(19) United States
(12) Patent Application Publication
(10) Pub. No.: US 2010/0306544 A1
(43) Pub. Date: Dec. 2, 2010

(54) SECURE COMPUTING ENVIRONMENT IN A TRANSPORTABLE CONTAINER

(75) Inventors: Chris Lionetti, Duvall, WA (US); Sompong Paul Olarig, Pleasanton, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/476,890

(22) Filed: Jun. 2, 2009

(51) Int. Cl. H04L 9/32; G06F 12/14; H04L 9/08; H04L 9/00

(52) U.S. Cl. 713/171; 713/194; 380/278; 726/34; 380/277; 713/150

(57) ABSTRACT

A secure container can comprise a security server, one or more container servers, and one or more sensors that can detect a breach of the physically secure computing environment provided by the container. A management server external to the container can be informed when the container is sealed and authorized and can subsequently provide a cryptographic key enabling the security server in the container to boot. Each container server can request and receive a cryptographic key from the security server enabling them to boot. If the container is breached, such keys can be withheld and any computing device that is powered off, or restarted, will be unable to complete a subsequent boot. If the container loses a support system and is degraded, so long as the security server does not lose power, it can provide the cryptographic keys to container servers restarted after the degradation is removed.

### BACKGROUND

As computing devices have become more ubiquitous, a greater quantity of private data has been processed by computing device and has been stored on computer-readable storage media. Consequently, a significant amount of research and development has been directed towards the design and implementation of computer-executable processes that can protect private data from unintended and unauthorized access. Such processes include password and encryption technology that can protect against unauthorized access of data, firewall technology that can protect against unauthorized access of data through network connections, anti-malware technology that can protect against unauthorized modification or deletion of data, and other like technologies.

Computer-executable processes that can protect data, however, are limited in that they protect against unauthorized computer-based access, modification and deletion of data. Physical access, such as physical access to the computer-readable storage media on which such data is physically stored, can enable determined individuals to bypass many of these computer-executable processes. For example, firewalls, anti-malware processes and other like technologies need to be executing in order to provide data protection and, consequently, offer no protection to a computer-readable storage medium itself, outside of the context of an executing computing device. Data on a computer-readable storage medium can be encrypted, and thus protected even from those who have physical access to the computer-readable storage medium, but only to the extent that the content of the data may not be revealed. An individual who has physical access to computer-readable storage media can still physically destroy the storage media and, thereby, delete or otherwise alter the data.

To protect against unauthorized physical access to computing devices and computer-readable media, including storage media, that retain or otherwise utilize private data, more traditional protection methodologies can be utilized. For example, relevant computing devices and computer-readable media can be placed in a locked room or other area to which physical access is limited. Additionally, sensors, such as light and motion sensors can be utilized to detect unauthorized physical intrusion into a protected room. Such protections against physical access are, however, incompatible with transportability, since the very purpose of such protections are to prevent the removal of computing devices and computer-readable media from the physically protected location.

### SUMMARY

Situations can arise in which it would be helpful, or even necessary, to provide a physically protected computing environment in an area in which it can be difficult to construct such an environment or provision one from existing structures. In one embodiment, therefore, a secure container can be provided that is sized and designed such that it can be physically transported in a convenient manner to a location at which it is desired to establish a secure computing environment. Such a secure container can comprise support systems relevant to providing a physically protected computing environment, including an auxiliary power supply, cooling equipment, a variety of sensors that can detect physical intrusion, and other like equipment. The secure container can further comprise one or more computing devices, computer-readable storage devices, networking devices, and other like devices that can benefit from the secure computing environment provided by the secure container.

In another embodiment, the secure container can be physically inspected and, when proper operation has been verified, the secure container can be physically sealed. Subsequently, the secure container can be authorized through a management server computing device that is located outside of the secure container, such as at a remote facility.

In a further embodiment, a secure container can comprise a security server computing device that can receive security-related information from the secure container's sensors and can provide, if appropriate, keys to the server computing devices executing within the container. The keys provided by the security server can enable the container servers to start up properly and access their data. The security server can request and receive, if appropriate, a key from the management server that can enable the security server to start up properly and access its data.

In a still further embodiment, if a breach of a seal of the secure container is indicated, the security server can cease providing keys to the container servers and the container can be de-authorized at the management server. Container servers that are executing, however, can remain executing. After the container has been resealed and reauthorized, the management server can again provide keys to the security server and the security server can provide keys to the container servers.

In a yet further embodiment, if a degraded condition is detected, such as the loss of power, cooling, or network connectivity, container servers can be gracefully shut down to, for example, conserve power or reduce heat generation. If the degraded condition is repaired while the security server and the sensors have remained operational and can verify that the container has not been breached, then the security server can continue to provide keys to the container servers when they are restarted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a relief diagram of an exemplary secure container;

FIG. 2 is a block diagram of an exemplary computing device executing within the secure container;

FIG. 3 is a block diagram of an exemplary key provisioning procedure within the context of the secure container;

FIG. 4 is a block diagram of an exemplary response to an unsealing of the secure container;

FIG. 5 is a state diagram of the states of operation of the secure container; and

FIG. 6 is a flow diagram of an exemplary operation of the secure container.

### DETAILED DESCRIPTION

The following description relates to the establishment and maintenance of a physically secure computing environment that can be established in insecure areas. A secure container, such as can be transported by traditional transportation equipment, can be provisioned with sensors to monitor the physical security of the secure container. A security server within the container can monitor the sensors and can, if the container is breached, cease to provide keys to servers executing within the container. Without such keys the container servers will not be able to start up and access data properly, thereby protecting the data stored thereon. The security server can itself receive a key, so that it can start up properly, from a management server that is external to the container. A properly sealed container can be authorized at the management server, which can enable the management server to provide the container's security server with its key. Unsealing of the container can de-authorize it and, consequently, cause the management server to cease providing the security server's key to that container's security server.

The techniques described herein focus on, but are not limited to, the described secure container. To the contrary, the techniques described herein are equally applicable to any computing environment that is to be physically secured, which can range in size from a case for a portable computing device, or even smaller environments, to a building or even larger environments. Consequently, while the descriptions below make reference to the specific implementation of the secure container, the scope of the mechanisms described is not intended to be so limited.

Additionally, although not required, some of the descriptions below will be in the general context of computer-executable instructions, such as program modules, being executed by one or more computing devices. More specifically, some of the descriptions below will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments where tasks are performed by remote processing devices that are linked through a communications network. In a distributed computing environment, program modules may be located in both local and remote memory storage devices.

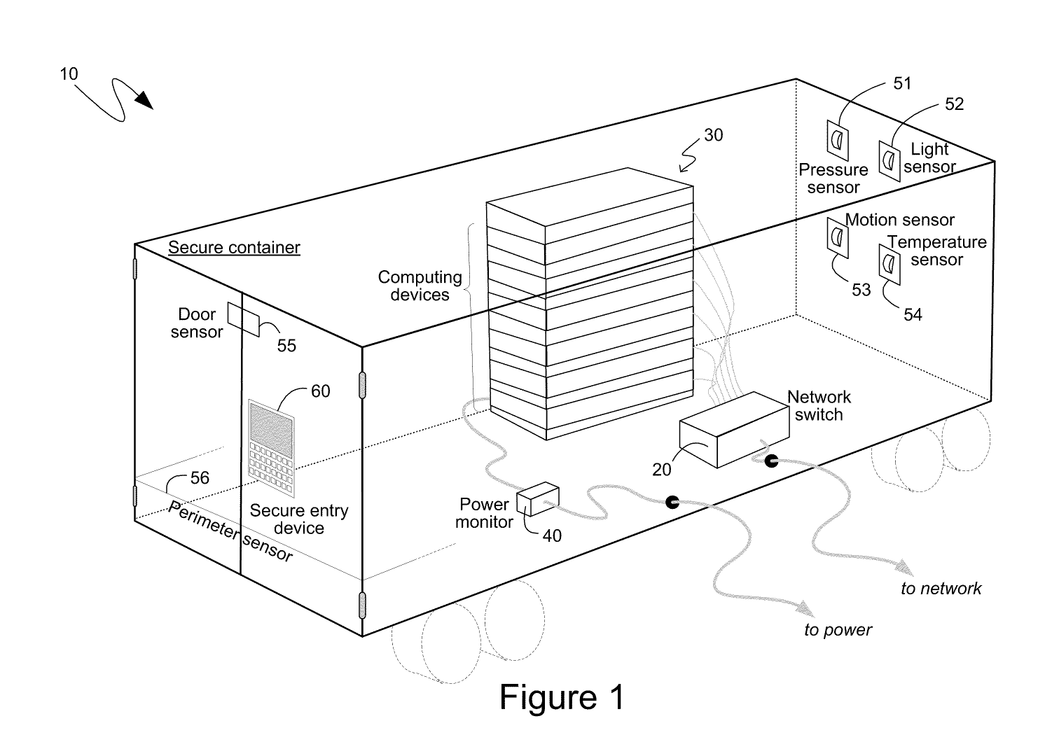

Turning to FIG. 1, an exemplary secure container 10 is illustrated comprising a network switch 20 or other network connectivity hardware, one or more computing devices 30, a power monitor 40, a variety of sensors, such as the pressure sensor 51, light sensor 52, motion sensor 53, temperature sensor 54, door sensor 55 and perimeter sensor 56, and a secure entry device 60. In one embodiment, the secure container 10 can be sized such that it can be easily transported by conventional transportation means, including, for example, by truck, train, boat, or other similar transportation mechanism. As will be known by those skilled in the art, shipping containers already exist that are designed to be compatible with most transportation mechanisms and such already existing containers can be utilized to develop and provision the secure container 10 of FIG. 1.

As indicated previously, in one embodiment, the secure container 10 can provide a physically secure computing environment that can be efficiently delivered to locations that may not be able to otherwise provide physical security for a computing environment. For example, the secure container 10 can be constructed and provisioned in advance at an offsite location, such as a factory or other place of manufacture. Subsequently, a need for such a secure computing environment may arise, such as, for example, due to a temporary event, such as a convention or sporting event, or due to a destructive event that can have impacted already existing infrastructure, such as, for example, a natural disaster or act of terrorism. In response to such a need, the secure container 10 can be transported to a relevant location and can be set up at that location to provide a physically secure computing environment.

In one embodiment, the secure container 10 can be connected to both a power supply and a network connection, as shown in FIG. 1. The power supply can include an Uninterruptable Power Supply (UPS), such as a battery-based or generator-based UPS. Similarly, the network connection can include both wired network connections and wireless network connections.

Once the secure container 10 has been provisioned with power and network connectivity, an initial inspection of the secure container 10 can occur. Such an initial inspection can verify proper operation of the provided power and network connectivity. Such an initial inspection can also verify the proper operation of the sensors and other accessories of the secure container 10. For example, the initial inspection can verify that the pressure sensor 51 can detect changes in air pressure within the secure container 10 with an appropriate degree of accuracy. Likewise, the initial inspection can verify that the light and temperature sensors can detect changes in the quantity of light and the temperature inside the secure container 10 with an appropriate degree of accuracy. The motion sensor 53 can also be verified for proper sensitivity, the door sensor 55 and the perimeter sensors 56 can be verified for proper operation, and the power monitor 40 can be verified that it can detect a degradation to the amount of power available to the secure container 10.

As will be recognized by those skilled in the art, the pressure sensor 51, light sensor 52, motion sensor 53, temperature sensor 54, door sensor 55 and perimeter sensor 56 and power monitor 40 are merely examples of the sensory equipment that can be installed and utilized within the secure container 10. The secure container 10 is intended to be equipped with a sufficient quantity of sensors from whose sensory data a reasonable determination can be made as to whether the physical protections provided by the secure container have been breached and whose sensory data can provide a reasonably small possibility that a physical breach could occur without detection. Consequently, the described initial inspection is strictly exemplary, though any initial inspection would need to be sufficient to provide a reasonable basis for believing that the sensors and other accessories of the secure container 10 were operating in an acceptable manner.

In one embodiment, as part of setting up the secure container 10, a Virtual Local Area Network (VLAN), or similar secure network communicational mechanism, can be established between a container security server computing device (for ease of reference, referred to herein as a “security server”) that can be one of the computing device 30 illustrated in FIG. 1, and a cryptographic keys management server computing device (for ease of reference referred to herein as a “management server”) that can be located externally to the secure container 10. For example, a VLAN could be established by providing unique identifying information, such as a Media Access Control (MAC) address of both the security server and the management server to the network switch 20 or similar networking hardware. The network switch 20 can then establish a VLAN, or similar secure network communicational mechanism, that can limit communications with the management server to only the security server of the secure container 10.

The security server of a secure container, such as the secure container 10, can be communicationally coupled to the sensors of the secure container so that the security server can be provided information from which an intrusion or other degradation of the physical security and support provided by the secure container 10 may be impacted, diminished, or breached. As such, the initial inspection of the secure container 10 can, in one embodiment, also include verification that the sensors, such as the pressure sensor 51, light sensor 52, motion sensor 53, temperature sensor 54, door sensor 55, perimeter sensor 56, power monitor 40, or any other sensors that the secure container can be equipped with, are properly communicationally coupled to the security server of the secure container.

Once an initial inspection and setup of the secure container 10 can be completed, the secure container can be sealed, such as by locking, or otherwise securing the access points of the secure container, including, for example, arming the door sensor 55 and the perimeter sensor 56, which, as will be known by those skilled in the art, can be configured to detect a breach of the physical shell of the secure container 10. Additionally, as shown in FIG. 1, the secure container 10 can be locked through the use of a secure entry device 60, such as a keypad, fingerprint reader, retinal scanner, or other like device. The sealed secure container 10 can then be authorized, such as by indicating appropriate information to a computing device, such as the management server computing device, that can be located outside of the secure container 10. In one embodiment, the management server can be located at a centralized location associated with multiple secure containers, such as the secure container 10, that have been set up at various locations where there was a need for a physically secure computing environment. Thus, in such an embodiment, once a secure server, such as the secure server 10, is inspected and sealed, the management server can be contacted, such as through a remote login, and the secure container 10 can be authorized.

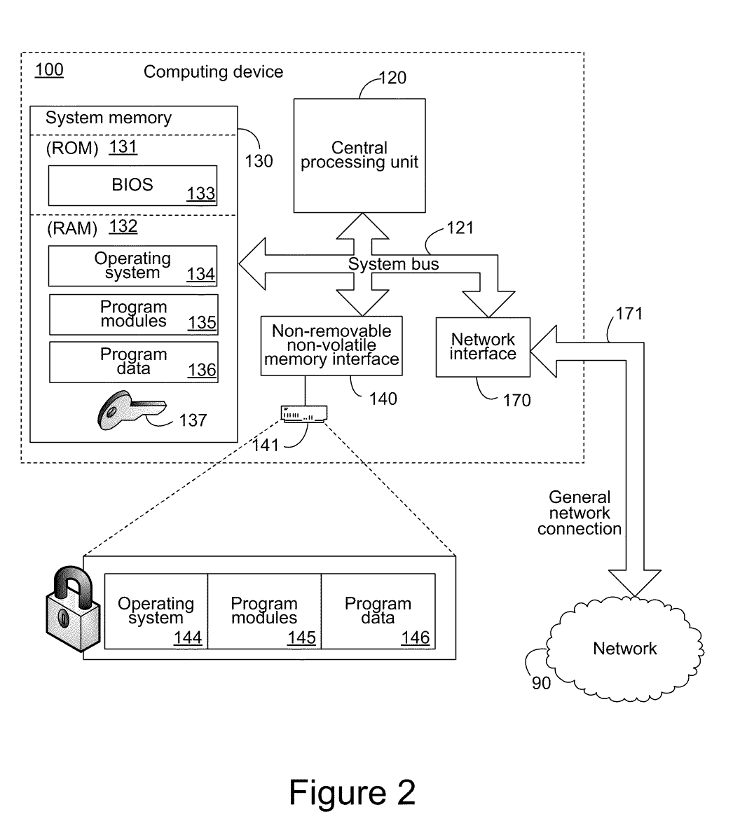

Mechanisms that can rely on the physical infrastructure described above, and, in association with such physical infrastructure, provide for protection of computer-readable data utilized by computing devices within the secure container 10, are described further below. However, before proceeding with such descriptions, a more detailed description of an exemplary computing device is provided. Turning to FIG. 2, an exemplary computing device 100 is illustrated that can represent any of the computing devices 30 (of FIG. 1) executing within the secure container 10 (also of FIG. 1), or any computing device executing outside of such a secure container, such as, for example, the management server referenced above. The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus or point-to-point architectures.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates an operating system 134, program modules 135, program data 136 and one or more cryptographic keys 137.

The computing device 100 may also include other removable/non-removable, volatile/nonvolatile computer storage media. By way of example only, FIG. 2 illustrates a hard disk drive 141 that reads from or writes to nonvolatile magnetic media. Other removable/non-removable, volatile/nonvolatile computer storage media that can be used with the exemplary computing device include, but are not limited to, solid-state based storage devices, such as Solid State Disks (SSDs), magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing an operating system 144, program modules 145, and program data 146. Note that these components can either be the same as or different from operating system 134, program modules 135 and program data 136. Operating system 144, program modules 145 and program data 146 are given different numbers here to illustrate that, at a minimum, they are different copies.

In one embodiment, the operating system 144, program modules 145 and program data 146, as stored on the hard disk drive 141 can be in an encrypted form, as shown in FIG. 2. To access such encrypted information, the computing device 100 can utilize one or more cryptographic keys 137 that can be retained in volatile memory, such as the RAM 132 to decrypt the operating system 144, program modules 145 and program data 146, as stored on the hard disk drive 141. Thus, in such an embodiment, the operating system 134, program modules 135 and program data 136 as retained in the RAM 132 can differ from the operating system 144, program modules 145 and program data 146 as stored on the hard disk drive 141 in at least one material aspect: the operating system 134, program modules 135 and program data 136 as retained in the RAM 132 can be retained in an unencrypted state. However, were the computing device 100 to be restarted, shut down, or otherwise deactivated, such that the contents of volatile storage, such as the RAM 132, were irretrievably lost, then, upon a subsequent restart, the computing device 100 could first seek to reacquire the one or more cryptographic keys 137 before accessing and decrypting the operating system 144, program modules 145 and program data 146 from the hard disk drive 141.

Of relevance to the descriptions below, the computing device 100 may operate in a networked environment using logical connections to one or more remote computers. For simplicity of illustration, the computing device 100 is shown in FIG. 2 to be connected to a network 90 that is not limited to any particular network or networking protocols. The logical connection depicted in FIG. 2 is a general network connection 171 that can be a local area network (LAN), a wide area network (WAN) or other network. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

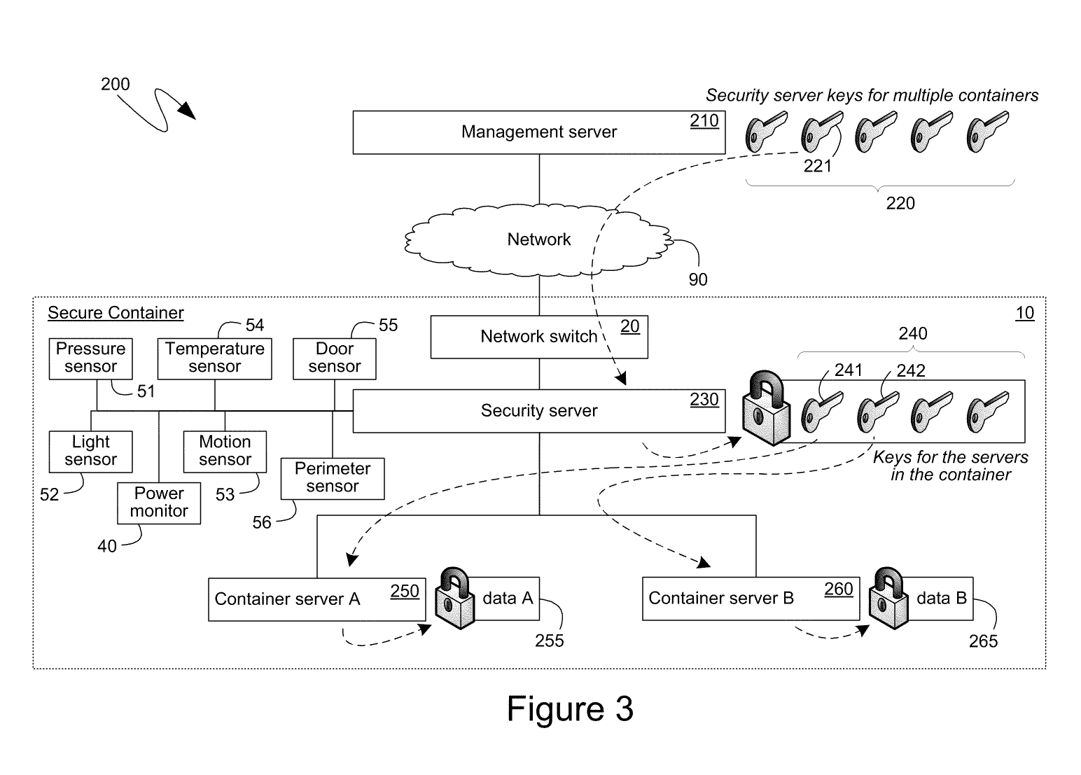

Turning to FIG. 3, the system 200 illustrates an exemplary key exchange mechanism for enabling the intended operation of the server computing devices within the secure container 10. As shown, the system 200 of FIG. 3 comprises two exemplary server computing devices 250 and 260 that are within the secure container 10 and can provide server computing functionality. In one embodiment, the container servers 250 and 260 can be among the computing devices 30 illustrated in FIG. 1, and can further conform to the above descriptions of the exemplary computing device 100 of FIG. 2.

As indicated above, in one embodiment, the container servers 250 and 260 can have associated with each of them data stores, such as the data 255 and the data 265, respectively, that can be encrypted and for which the container servers 250 and 260 can utilize a cryptographic key to access. For example, the data 255 can comprise most or all of the stored data utilized by the container server 250, including at least some portions of the operating system of the container server 250, such that, absent an appropriate cryptographic key, the container server 250 may not even be able to complete its booting process. Such a key can be referred to by those of skill in the art as a “boot key.” Boot keys can be implemented in conjunction with known, existing cryptographic systems and processes, including, for example, whole hard drive, or other storage device, encryption systems, Trusted Platform Group (TPM) modules that limit access to specific components or information, and other like systems and processes.

Consequently, when a container server, such as the container servers 250 and 260, initially starts, or subsequently restarts, it can request an appropriate cryptographic key from the security server 230 that can also be executing within the secure container 10. As indicated previously, the security server 230 can be communicationally coupled to the sensors of the secure container 10 including, for example, as shown in the system 200, a pressure sensor 51, a temperature sensor 54, a door sensor 55, a light sensor 52, a power monitor 40, a motion sensor 53 and a perimeter sensor 56. In one embodiment, the security server 230 can determine, based at least in part on the inputs provided by such sensors, whether or not to provide the cryptographic key to a requesting container server that can enable that container server to complete its booting process and resume normal operation. More specifically, if the security server 230 detects a breach of the secure environment provided by the secure container 10, such as would be indicated by one or more of the sensors that are communicationally coupled to the security server 230, the security server can decline to provide requested cryptographic keys to the requesting container servers, thereby protecting the encrypted data from potentially malicious access.

In the illustrated embodiment of the system 200, however, no breach or other degradation of the secure container 10 can be occurring and, as a result, the security server 230 can provide requested cryptographic keys to the requesting container servers. Thus, as shown, when the container server 250, for example, powers on, or is otherwise reset, it can request a cryptographic key from the security server 230 that can decrypt the data 255 associated with the requesting container server 250 and, thereby, enable the container server 250 to access its operating system and other application programs, as well as any associated data utilized by such a server computing device. The security server 230 can, upon receiving such a request, identify the cryptographic key 241 associated with the container server 250 and can provide it to the requesting container server 250, thereby enabling the container server 250 to complete its booting and resume normal operation.

If the security server 230 had not previously provided the container server 250 with a cryptographic key, then the data 255 may not be encrypted. In such a preliminary exchange, the security server 230 can generate the cryptographic key 241 and can provide it to the container server 250. Subsequently the container server 250 can encrypt the data 255 in an appropriate manner to enable it to be subsequently decrypted with the cryptographic key 241.

Additionally, in another embodiment, one or more of the container servers, such as the container servers 250 and 260, can implement virtualization technology, such as virtual machines or other virtualized server computing devices. In such a case, each virtualized machine can present itself to the security server 230 as an independent entity and can receive from the security server an independent cryptographic key.

The security server 230 can retain generated cryptographic keys 240, which can comprise the cryptographic key 241 for the container server 250, the cryptographic key 242 for the container server 260, and other cryptographic keys for one or more of the other container servers of the secure container 10. In one embodiment, the cryptographic keys 240, as well as other data relevant to the security server 230, including, for example, its own operating system and application programs, can be encrypted such that the security server 230 cannot boot or otherwise access this encrypted data without a cryptographic key of its own. Such a cryptographic key can be provided to the security server 230 by the management server 210. As indicated previously, a VLAN or similar protected network connection can be established between the security server 230 and the management server 210 across the network 90. For example, as illustrated in the system 200, the network switch 20 of the secure container 10 can aid in establishing such a VLAN. Subsequently, when the security server 230 is initially powered on, or subsequently restarted, it can request the cryptographic key from the management server 210 that can enable the security server 230 to complete its booting process and generate, or access previously generated, cryptographic keys 240. The management server 210 can, in turn, provide a cryptographic key 221 for the security server 230 if the secure container 10 has been sealed and authorized, such as in the manner described above. As before, if the security server 230 has not previously requested a cryptographic key, the management server 210 can generate one and the security server 230 can encrypt its data such that it can be decrypted by the provided cryptographic key.

The management server 210 that can be located externally to the secure container 10 can comprise cryptographic keys 220 for multiple secure containers' security servers. The management server 210, therefore, can serve multiple secure containers 10. While, as will be recognized by those skilled in the art, multiple iterative layers can be provided for, such that the management server 210 receives a boot key from a subsequently higher layer server, for purposes of clarity of explanation, the below descriptions will proceed with the assumption that the management server 210 remains operational throughout the described scenarios. For example, since the management server 210 can be located externally to the secure container 10, it can be located such that it is provided with multiple redundancies in support and security systems.

As can be seen from the system 200, in normal operation, once the secure container 10 is sealed, as detailed above, the security server 230 can be started and it can request the cryptographic key 221 from the management server 210. If the secure container 10 has been authorized, the management server 210 can provide the cryptographic key 221 to the security server 230, thereby enabling the security server to complete its booting process and assume normal operation. As part of that normal operation, when one or more of the container servers, such as container servers 250 and 260, request their own cryptographic keys 241 and 242, respectively, the security server 230 can provide those keys if, for example, none of the sensors which maintain a communicational connection to the security server indicates a breach of the secure container 10, or otherwise indicates a degraded condition.

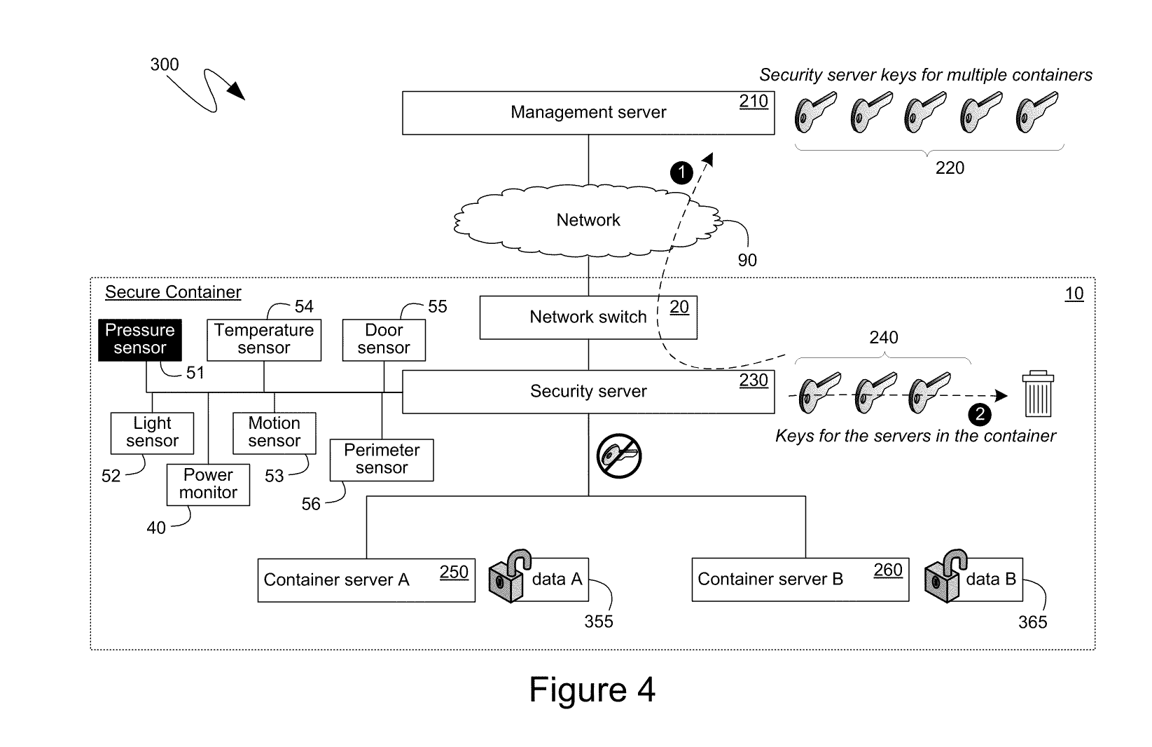

However, should one or more of the sensors of the secure container 10, such as the exemplary monitors and sensors 40, 51, 52, 53, 54, 55 and 56, indicate that the secure container has been breached, the security server 230 can take action to protect the data of the computing devices 30 of the secure container. Turning to FIG. 4, an exemplary breached system 300, is illustrated, wherein, as an example, the pressure sensor 51, as indicated, can be reporting a breach condition to the security server 230. In response to such a breach, the security server 230 can, as shown, cease to provide or generate cryptographic keys for the container servers, such as the container servers 250 and 260. In addition, as an optional additional security measure, the security server 230 can attempt to provide a copy of the cryptographic keys 240 to the management server 210, which is external to the secure container 10, for safekeeping. If such a copy succeeds, the security server 230 can then proceed to, again, optionally, securely erase the cryptographic keys 240 from non-volatile storage, retaining them only in volatile storage, such as the RAM 132.

As shown in the system 300, if the container servers, such as the container servers 250 and 260, were operating normally when the pressure sensor 51 indicated the breach condition, the data 355 and 365, respectively, of such container servers can be in an decrypted state as it is retained in, and being utilized from, each container server's volatile memory, such as the RAM 132. To prevent unnecessary termination of the services provided by such container servers 250 and 260, in one embodiment, the container servers can continue to operate despite the breach being indicated by the pressure sensor 51. However, should any of the container servers, such as the container servers 250 and 260, be powered off or restarted, the unencrypted data 355 and 365 would be lost from the volatile memory, and the container servers would again ask for their cryptographic keys from the security server 230. Since, as indicated, the security server 230 can, due to the breach being indicated by the pressure sensor 51, refuse to provide cryptographic keys to the container server, any container server that was powered off, or otherwise restarted, would not be able to complete its boot process, nor would it be able to access its data and, consequently, its data would remain encrypted and, thereby protected.

For example, if the secure container 10 was breached by a malicious individual entering the secure container 10, a number of sensors could indicate such a breach, including the motion sensor 53 (which could detect the malicious individual moving within the secure container), the light sensor 52 (since the malicious individual would need to introduce light into the unlit container to see what they were doing), the pressure sensor 51 (since the container could have been slightly pressurized or depressurized and the resulting breach could have equalized the pressure with that of the outside), the perimeter sensor 56 (since some portion of the physical shell of the secure container 10 would need to be penetrated to enable the malicious individual to enter), and possibly the door sensor 55 (if the malicious individual entered through the doors of the secure container). In response, the security server 230 can cease to provide cryptographic keys to the container servers, though the container servers can continue to execute with decrypted data in volatile memory. Should the malicious individual seek to access the data of the container servers by physically removing one or more of the container servers from the secure container 10, the resulting loss of power during such a move will result in the loss of the decrypted data from the container server's volatile memory and, upon a subsequent restart, the container server will not be provided with the relevant cryptographic key and will, consequently, not be able to reboot or otherwise access the data stored on the non-volatile storage media in an encrypted form. The data, therefore, can remain encrypted and, thereby protected. Alternatively, should the malicious individual seek to access the data of one or more container servers by physically attaching or inserting a device into the container server, again, a resulting power loss can cause the loss of decrypted data in volatile memory and a subsequent restart can fail due to the non-provision of relevant cryptographic keys from the security server 230.

Consequently, to ensure that the relevant cryptographic keys for decrypting data are not available should the secure container 10 be breached and one or more of the computing devices 30 be stolen or otherwise tampered with, in one embodiment, cryptographic keys provided to servers, including the cryptographic keys 241 and 242 (identified in FIG. 3) provided to the container servers 250 and 260, respectively, and the cryptographic key 221 provided to the security server 230, can be retained by the receiving server computing device only in volatile memory and not stored on non-volatile memory. Any resulting power loss, restart, or reboot of such a server computing device can result in the loss of the cryptographic key that can decrypt the computing device's data and enable the computing device to complete its booting operation, thereby forcing the computing device to request such a cryptographic key from another computing device, such as the security server 230 or the management server 210, that can refuse to provide such a cryptographic key if the secure container 10 was unsealed. In such a manner, the data of the computing devices 30 of the secure container 10 can remain protected in the event of malicious physical access.

In another embodiment, the secure container 10 may not be physically breached, but can, nevertheless, operate in a degraded state. For example, if the network switch 20 were to lose connectivity to the network 90, the container servers may not be of much use, since it is likely that they can have lost contact with their clients and may not be providing useful services over the network 90 any longer. However, such a loss of network connectivity can be a precursor to more malicious activity, and, as a precaution, the security server 230 can, optionally, securely delete the cryptographic keys 240 from a non-volatile storage medium where it may have stored them, if it has previously provided, or can, again optionally, provide a copy of the cryptographic keys 240 to the management server 210. Subsequently, if the connection to the network 90 is restored, the security server 230 can resume normal operation and can resume providing cryptographic keys to requesting container servers.

As another example, the secure container 10 can lose connection to its primary electrical power, or to its cooling systems. In such a case, continued operation of the container servers, such as the container servers 250 and 260, may be unwise, since such continued operation could result in a faster depletion of any UPS power systems that may be active in the event of a primary power loss, or it could result in a faster increase in temperature inside the secure container 10 should the cooling system have ceased operation. Consequently, in such cases, the container servers can be systematically and, if possible, gracefully shut down. The security server 230, however, can remain operational to monitor the sensors of the secure container 10. If primary power is restored before all UPS power systems fail, or if the cooling system is restored before the temperature exceeds upper thresholds, then the security server can proceed to provide cryptographic keys 240 to the container servers as the container servers restart and request such keys. In such a manner, the secure container 10 can resume non-degraded operation.

However, if the security server 230 is forced to cease processing, such as, for example, if no UPS power remains and the security server 230 is left without power, or, as another example, if the temperature inside the secure container 10 increases beyond the security server's operating thresholds due to a cooling system failure, then the security server 230 can no longer be assured that a breach of the secure container did not occur while the security server was inactive. As a result, such a complete loss of power, or other degradation that is not repaired prior to the deactivation of the security server 230 can be treated as if the secure container 10 was breached. Consequently, such as in the manner described in detail above, the security server 230 can be denied a cryptographic key by the management server 210 and can, thereby, be prevented from completing its booting operation. Each of the container servers, such as the container servers 250 and 260, can, likewise, not receive their cryptographic keys from the security server 230, since the security server has not completed its booting operation and is not, therefore, operating normally.

Subsequent to a breach event, including a breach event detected by one or more of the sensors of the secure container 10, the secure container can be re-inspected in a manner analogous to the initial inspection detailed above. Once the secure container 10 has been restored to proper operating condition, it can be resealed and reauthorized, such as at the management server 210, again, in the manner described in detail above. Subsequent requests for cryptographic keys from the security server 230 of the secure container 10 can, then, be responded to by the management server 210, thereby enabling the security server 230 to resume normal operation and provide cryptographic keys to the container servers to enable them to do likewise.

In one embodiment, a secure container, such as the secure container 10, can comprise multiple security servers, such as the security server 230. Multiple security servers can increase the uptime of the container servers, such as container servers 250 and 260, and decrease the de-authorization of the secure container 10. For example, if the secure container 10 had lost the connection to the network 90, and, subsequently, the security server 230 was restarted due to a timed upgrade deployment, the security server would not be able to complete the restart, since it could not contact the management server 210 to obtain its cryptographic key 221. Any restarting container server, such as the container servers 250 or 260, would, likewise, not be able to complete restarting since they could not obtain their cryptographic keys 241 and 242, respectively, from the security server 230. If the secure container 10 comprised multiple security servers, however, at least one security server could remain operational while another was restarted. Then, in the case of, for example, degraded operation, even if the restarted security server could not complete its booting process due to the unavailability of the connection to the management server 210, the other security server could continue to provide cryptographic keys to the container servers, should the secure container 10 not otherwise be breached.

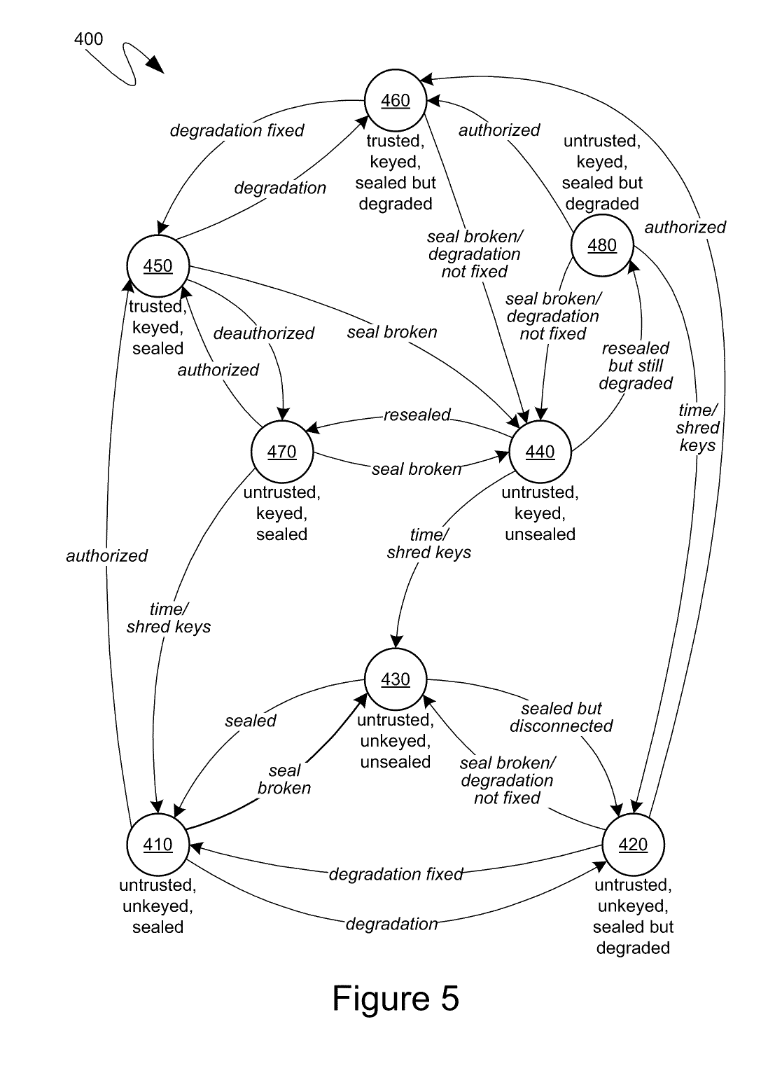

Turning to FIG. 5, a state diagram 400 provides a visual representation of the above-described states of the secure container 10. Initially, the secure container 10 can be in an untrusted, unkeyed and unsealed state 430. Once the secure container 10 is delivered to a location at which it is needed, it can be inspected, as described above, and subsequently sealed. The act of sealing the secure container 10 can move it to the untrusted, unkeyed, sealed state 410. Should the seal, at that point, be broken, the secure container 10 can return to the state 430. If, after the secure container 10 has been sealed and is at state 410, a support system, such as power, network connectivity, or cooling, fails, the secure container can transition to the untrusted, unkeyed, sealed but degraded state 420. If the support system is restored before the security server 230 fails, the secure container 10 can return to the state 410. However, if the support system is not restored on time, the seal can be considered to have been broken, as described above, and the secure container 10 can return to state 430. Additionally, if the secure container 10 is sealed before an impaired support system is repaired, the secure container can transition from the state 430 to the state 420.

Once the secure container 10 is sealed, such as in state 410, or in state 420 if it was sealed while in a degraded state, the secure container can be authorized, such as in the manner described in detail above. In the case of the untrusted, unkeyed, sealed state 410, authorizing the secure container 10 can move it to the trusted, keyed, sealed state 450 since the security server 230 would then be able to receive its cryptographic key from the management server 210 and would, likewise, provide or generate cryptographic keys for the container servers. The trusted, keyed, sealed state 450 can be the typical and normal operating state for the secure container 10. Alternatively, if the secure container 10 was in the state 420, a subsequent authorization can move it to the trusted, keyed sealed but degraded state 460. From there, a subsequent repair of the degradation can place the secure container 10 back in the state 450. Similarly, a degradation, such as an impairment to a support system, can move the secure container 10 from the normal operating state 450 to the state 460.

As described above, if an impairment to a support system is not repaired or otherwise remedied within a sufficient amount of time, the security server 230 can be forced to cease operation and, because the security server can no longer monitor the sensors of the secure container 10, the security server cannot be certain that the secure container 10 was not unsealed. Consequently, as shown in the state diagram 400, if the secure container 10 is in the trusted, keyed, sealed but degraded state 460, and the support systems are not restored or repaired, the secure container can transition to the untrusted, keyed, unsealed state 440. A transition from the state 460 to the state 440 can, likewise, occur if the secure container 10 is, actually, unsealed, such as through an unauthorized entry.

In the untrusted, keyed, unsealed state 440, servers, such as the container servers, that have already been provided a cryptographic key can continue operating normally, but servers that request a cryptographic key can be denied and can, thereby, not complete their boot process. If the secure container 10 is subsequently sealed, it can transition to an untrusted, keyed, sealed state 470 or, alternatively, if the secure container is sealed but the impairment to a support system has not yet been fully repaired, the secure container can, instead, transition to the untrusted, keyed, sealed but degraded state 480. From the untrusted, keyed, sealed state 470, if the seal is broken again, the secure container 10 can return to the state 440, as it can if the seal is broken or the degradation is not repaired on time from the untrusted, keyed, sealed but degraded state 480.

In a state where the secure container 10 is in an untrusted state, but executing servers within the container have previously been “keyed”, or provided with the cryptographic keys that can enable those servers to boot properly and assume normal operation, if the server is not reauthorized within a sufficient amount of time, eventually scheduled backups, accidental restarts, or even the directed destruction of cryptographic keys as retained in volatile or non-volatile memory, can result in the executing servers losing their cryptographic keys with no mechanism through which they can legitimately reacquire them, and, thereby, becoming “unkeyed.” Consequently, as shown in the state diagram 400, from the untrusted, keyed and sealed state 470, if the secure container 10 is not reauthorized within a sufficient amount of time, or if the servers are instructed to shred their cryptographic keys, the secure container can transition to the untrusted, unkeyed, sealed state 410. Similarly, if the secure container 10 was in the untrusted, keyed, unsealed state 440, such events could cause it to transition to the untrusted, unkeyed, unsealed state 430, while if the secure container was in the untrusted, keyed, sealed but degraded state, such events would cause it to transition to the untrusted, unkeyed, sealed but degraded state 420.

Returning to the normal operating state 450, if the secure container 10 is breached or otherwise unsealed, the secure container can transition from the normal operating state 450 to the untrusted, keyed, unsealed state 440. Alternatively, if the secure container 10 is deauthorized, such as through a manual action at the management server 210, it can transition to the untrusted, keyed and sealed state 470. A reauthorization of the secure container 10 can then return it to the normal operating state 450 from the untrusted, keyed, sealed state 470. Similarly, if the secure container 10 is in the untrusted, keyed, sealed but degraded state 480, it can still be reauthorized to the trusted, keyed, sealed but degraded state 460, as shown in the state diagram 400.

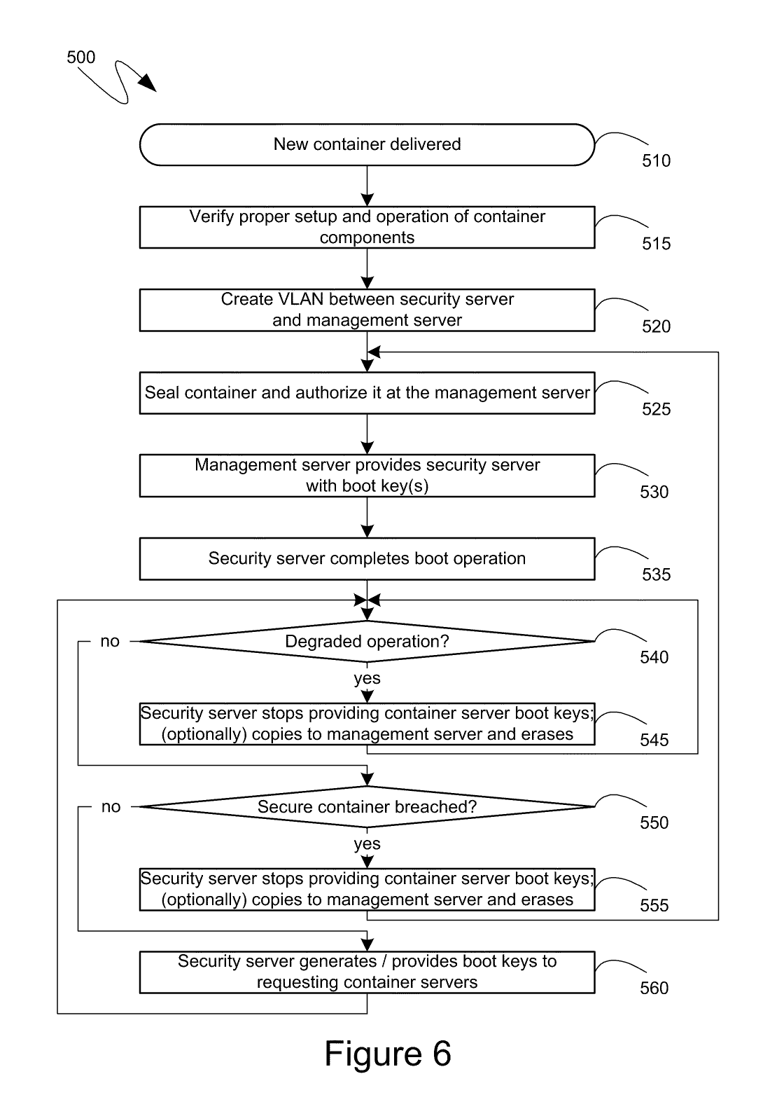

Turning to FIG. 6, the flow diagram 500 illustrates the establishment and operation of the secure container 10 in greater detail. As can be seen, initially, at step 510, a new secure container 10 can be delivered to a location at which a physically secure computing environment is desired. Subsequently, at step 515, proper setup and operation of various components of the secure container 10 can be verified or established. For example, in one embodiment, an individual knowledgeable about the secure container 10 can be sent to inspect the secure container and establish its proper operation. Alternatively, in another embodiment, automated computer-executable instructions can be executed at the secure container 10 to verify proper setup and operation of its components.

After the secure container 10 has been verified at step 515, at step 520 a VLAN, or similar secure networking construct can be established between the security server 230 of the secure container and a management server 210 that is external to the secure container. Once proper operation of the VLAN, or other construct, established at step 520 is determined, the secure container 10 can be sealed at step 525 and it can be authorized, such as through a manual or automated indication provided to the management server 210.

At some point subsequent to step 525, the security server 230 of the secure container 10 can request, as described in detail above, a cryptographic key from the management server. In response to such a request, if the secure container 10 is still authorized, the management server can, at step 530, provide the secure container's security server 230 with the requested cryptographic key. The provision of the cryptographic key at step 530 can enable the security server 230 of the secure container 10 to complete its boot operation at step 535. Subsequently, the security server 230 can monitor the sensors of the secure container 10.

If, at step 540, the security server 230 receives information from one or more of the sensors of the secure container 10 that the secure container has lost one or more support systems, such as primary electrical power, cooling, or network connectivity, the security server can determine that the container is operating in a degraded condition. As a result of such a determination at step 540, the security server 230 can, at step 545, stop providing or generating boot keys for the container servers, as described in detail above. In addition, as an optional precaution, the security server can further proceed, as part of step 545, to copy the cryptographic keys that it had previously generated for container servers up to the management server and, again, optionally, then delete such keys from the security server's local storage. Processing can then loop back to step 540. If, however, at step 540, the security server 230 does not receive any information from one or more of the sensors of the secure container 10 that indicates a degraded condition, or if the security server now receives information from one or more of the sensors indicating that the degraded condition has been repaired, processing can proceed to step 550.

At step 550, the security server 230 can receive information from one or more of the sensors of the secure container 10 that the secure container has been breached. If, at step 550, a breach is determined to have occurred, then, at step 555, the security server 230 can cease to provide and generate cryptographic keys for the container servers, again, as previously detailed. In addition, as, again, an optional portion of the step 555, the security server 230 can copy the cryptographic keys that it had previously generated for container servers up to the management server and then delete such keys from the security server's local storage. Processing can then loop back to step 525, since, as described previously, in one embodiment, the security server 230 will not perform other relevant actions, such as providing requested cryptographic keys to container servers, until the container is resealed and reauthorized at step 525.

As will be recognized by those skilled in the art, the steps 540 and 550 can be based on the same set of input from one or more of the sensors of the secure container 10, and, as such, can be performed in parallel. Thus, if at steps 540 and 550, the security server 230 determines that the secure container 10 is neither operating in a degraded condition, nor has it been breached, then at step 560, the security server can proceed to either generate, or provide previously generated, cryptographic keys for requesting container servers of the secure container 10. Processing can then loop back to step 540, thereby enabling the security server 230 to continuously monitor for degraded or breach conditions.

As can be seen from the above descriptions, a secure container with a security server that can limit when container servers can boot properly and access data has been provided. In view of the many possible variations of the subject matter described herein, we claim as our invention all such embodiments as may come within the scope of the following claims and equivalents thereto.

We claim:

1. One or more computer-readable media comprising computer-executable instructions for protecting data within a secure container, the computer-executable instructions directed to steps comprising:
receiving a request, from a container server internal to the secure container, for a container server cryptographic key associated with the container server that enables the container server to access encrypted data;
receiving sensor data from one or more sensors of the secure container;
providing the container server cryptographic key to the requesting container server if the sensor data has been received in an uninterrupted manner since the secure container was last sealed and if the sensor data indicates that the secure container has remained sealed since it was last sealed.

2. The computer-readable media of claim 1, comprising further computer-executable instructions directed to requesting, from a management server external to the secure container, a security server cryptographic key to access encrypted data; and utilizing the security server cryptographic key received from the management server to access security server encrypted data.

3. The computer-readable media of claim 2, comprising further computer-executable instructions directed to storing the security server cryptographic key received from the management server only in volatile memory.

4. The computer-readable media of claim 2, wherein the security server encrypted data comprises computer-executable instructions for booting a computing device executing the computer-executable instructions for protecting the data within the secure container.

5. The computer-readable media of claim 1, wherein the computer-executable instructions directed to the providing the container server cryptographic key to the requesting container server further comprise computer-executable instructions directed to generating the container server cryptographic key if the requesting container server has not previously been provided any container server cryptographic key; and storing the generated container server cryptographic key on non-volatile computer-readable storage media.

6. The computer-readable media of claim 1, comprising further computer-executable instructions directed to determining, based on the sensor data, that the secure container has been breached; and deleting container server cryptographic keys stored on non-volatile computer-readable storage media in response to the determining that the secure container has been breached.

7. The computer-readable media of claim 6, comprising further computer-executable instructions directed to providing, in response to the determining that the secure container has been breached, the container server cryptographic keys to a management server external to the secure container prior to the deleting.

8. A secure container comprising:
at least one connection to a network;
one or more container servers providing services over the network, wherein at least one of the one or more container servers requires a container server cryptographic key to access its data;
one or more sensors monitoring physical security of the secure container; and
at least one security server communicationally coupled to the one or more container servers and the one or more sensors, wherein the at least one security server provides the container server cryptographic key to the at least one of the one or more container servers if the communicational coupling between the at least one security server and the one or more sensors has remained uninterrupted since the secure container was last sealed and if sensor data from the one or more sensors indicates that the secure container has remained sealed since it was last sealed.

9. The secure container of claim 8, further comprising a network switch communicationally coupled to the at least one connection to the network, the network switch establishing a secure network communicational connection between the at least one security server and a management server external to the secure container.

10. The secure container of claim 9, wherein the management server provides a security server cryptographic key to the at least one security server if the secure container is authorized, and wherein further the security server requires the security server cryptographic key to access stored copies of container server cryptographic keys.

11. The secure container of claim 10, wherein the security server stores the security server cryptographic key only in volatile memory.

12. The secure container of claim 8, wherein the at least one of the one or more container servers stores the container server cryptographic key only in volatile memory.

13. The secure container of claim 8, wherein the at least one security server generates the container server cryptographic key if the at least one of the one or more container servers has not previously been provided any container server cryptographic key and stores the generated container server cryptographic key on non-volatile computer-readable storage media.

14. The secure container of claim 8, wherein the at least one security server determines, based on data from the one or more sensors, that the secure container has been breached and, in response to the determining, deletes container server cryptographic keys stored on non-volatile computer-readable storage media.

15. The secure container of claim 14, wherein the at least one security server provides, in response to the determining that the secure container has been breached, the container server cryptographic keys to a management server external to the secure container prior to the deleting.

16. The secure container of claim 8, wherein the at least one of the one or more container servers is a virtual container server process.

17. A method of authorizing a secure container comprising one or more container servers, one or more sensors and at least one security server, the method comprising the steps of:
verifying proper operation of the one or more sensors;
sealing the secure container after the verifying; and
authorizing the secure container with a management server external to the secure container, the authorizing enabling the management server to provide a security server cryptographic key to the at least one security server, the security server cryptographic key enabling the at least one security server to access its data.

18. The method of claim 17, wherein the secure container further comprises a network switch, the method further comprising the steps of provisioning, prior to the sealing, the network switch to provide for a secure network communicational connection between the at least one security server and the management server.

19. The method of claim 17, wherein the at least one security server provides container server cryptographic keys to at least one of the one or more container servers if the one or more sensors have provided sensor data to the security server in an uninterrupted manner since the secure container was last sealed and if sensor data from the one or more sensors indicates that the secure container has remained sealed since it was last sealed.

20. The method of claim 19, wherein the at least one security server stores the security server cryptographic key only in its volatile memory and wherein further the at least one of the one or more container servers stores the container server cryptographic key only in its volatile memory.
